(19) United States
(12) Patent Application Publication
(10) Pub. No.: US 2009/0025678 A1
(43) Pub. Date: Jan. 29, 2009

(54) Trinity pneumatic energy systems

(76) Inventor: Terry A. Maiers, Pine Grove, CA (US)

Correspondence Address: TERRY A. MAIERS, 202 E. 11th STREET, SMACKOVER, AR, 71762, US

(21) Appl. No.: 12/215,798

(22) Filed: Jun. 30, 2008

Related U.S. Application Data
(60) Provisional application No. 60/961,177, filed on Jul. 18, 2007.

(51) Int. Cl. F02B 1/12

(52) U.S. Cl. 123/27 R

(57) ABSTRACT

The invention is a process of components from existing technologies connected together in a manner that provides an alternative means of providing power to an internal combustion without the utilization of fossil or nuclear fuels as the primary means of power thus reducing or eliminating the adverse effects of the combustion process on the ecology and environment.

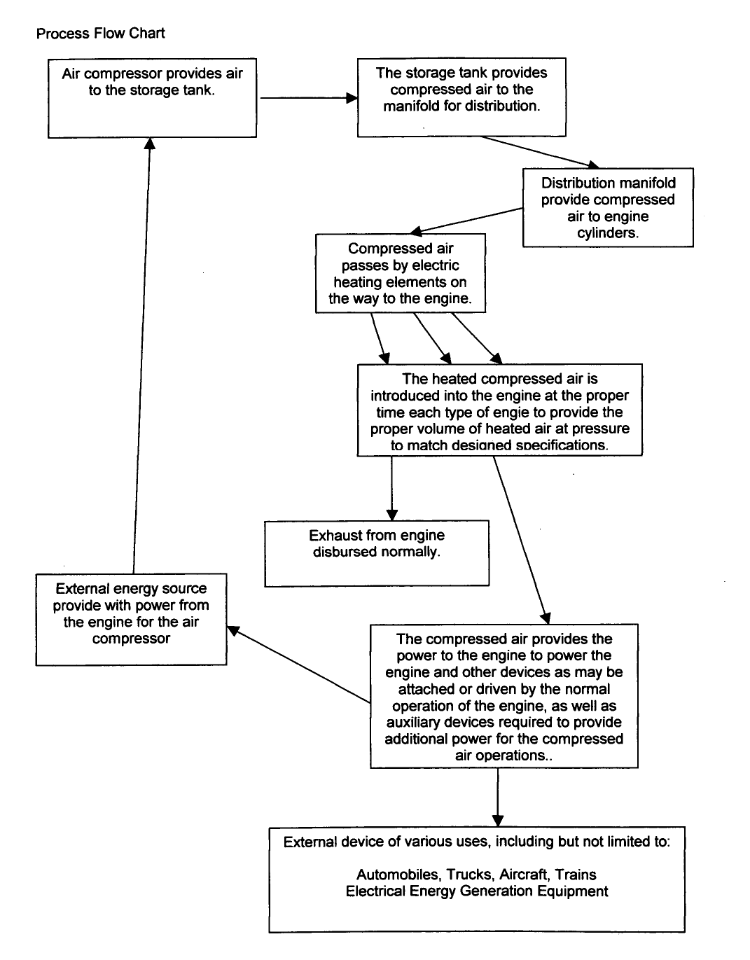

### CROSS-REFERENCE TO RELATED APPLICATIONS

This invention is referenced in Provisional Patent Application No. 60/961,177 filing date Jul. 18, 2007. The systems contained in the reference document are named the following:
Non-Combustion Operating System for Internal Combustion Engine
   Trinity Automotive Propulsion System
   Trinity Diesel Propulsion System
   Trinity Aircraft System
   Trinity Electrical Generation System
This filing shall consolidate all of the systems listed above into a single process for use in a variety of applications.

### STATEMENT OF FEDERALLY SPONSORED RESEARCH OR DEVELOPMENT

There is no Federally Sponsored Research and Development associated with this application.

### BACKGROUND OF THE INVENTION

1. Technical Field of the Invention

The technical field of the invention is the field of internal combustion engines.

2. Background Art

The invention is a system to provide energy from compressed air to generate power for the operation of existing internal combustion engines of varying types.

### BRIEF SUMMARY OF THE INVENTION

The invention is to provide a process for the utilization of current technology in new ways to provide an alternate means of powering internal combustion engines without significant changes to the underlying engineering and applicable systems.

### BRIEF DESCRIPTION OF THE DRAWINGS

This drawing contains a flow chart diagram of the invented process for utilization of compressed air to provide power for the operation of internal combustion engines of a generic nature.

### DETAIL DESCRIPTION

The invention is designed to provide process for the utilization of current technology for the generation of power for internal combustion engines for various uses.

The process involves the use of compressed air as the means of providing the power required by various types of engines for normal operations.

An air compressor will provide compressed air for the process while obtaining its power from a source that is outside the normal operation of the internal combustion engine being powered.

The compressed air for the operation of the engine will be stored in a separate storage tank of appropriate size and as needed to provide a minimal of operation in the event of compressor failure or for initial start-up operations.

The compressed air from the tank will be distributed to the engine via a manifold as required by each type of engine.

The compressed air will be heated by electric heating elements prior to entering the engine to increase the volume of the compressed air.

The compressor will be of an air-cooled or water-cooled model as deemed appropriate for the engine being powered.

The compressed air will be delivered to the engines via specially designed and engineered solenoids.

The compressed air will be exhausted from the engine utilizing the existing exhaust systems.

There is no intent in this process of utilizing exhausted compressed air for any other use.

1. An air compressor installed as part of the package of components comprising the process can provide an adequate power supply to operate an internal combustion engine without the use of fossil fuels or other types of combustion fuels.

2. A separate power source connected to but separate from the internal combustion engine will supply the air compressor in claim 1 with its operating power.

3. The energy produced by the internal combustion engine is sufficient to provide power to the separate power source in claim 2 for the air compressor power and provide sufficient power to the internal combustion engine to operate other devices as designed and engineered.

4. The Energy Balance of the systems is weighted on the side of the kinetic energy of the compressed air acting on the components of the internal combustion engine to create sufficient energy for the operation of the different components of the process so that the need for fossil or nuclear fuels for power generation is eliminated.

5. The air compressor in claim 1 requires less energy for the creation of the compressed air than is created by the internal combustion engine, thus is not in violation of the First Law of Thermodynamics.
